(19) United States
(12) Patent Application Publication
(10) Pub. No.: US 2008/0035172 A1
(43) Pub. Date: Feb. 14, 2008

(54) Method and Apparatus for Cleaning Consumable Drink and Food Containers

(76) Inventors: Gordon Scott Mindrum, Cincinnati, OH (US); Steven Craig Sefton, West Chester, OH (US); Olga Cubells Piehler, Loveland, OH (US)

Correspondence Address: FROST BROWN TODD, LLC, 2200 PNC CENTER, 201 E. FIFTH STREET, CINCINNATI, OH, 45202, US

(21) Appl. No.: 11/833,477

(22) Filed: Aug. 3, 2007

Related U.S. Application Data
(60) Provisional application No. 60/822,315, filed on Aug. 14, 2006.

(51) Int. Cl. B08B 1/00; A46B 11/00; A46B 13/02; A46B 15/00; B25G 1/10; A46B 9/02; A47L 25/00

(52) U.S. Cl. 134/6; 15/104.001; 15/104.94; 15/105; 15/143.1; 15/160; 15/22.2

(57) ABSTRACT

A cleaning apparatus configured to clean a consumable drink or food container includes a handle portion, a bristle base, and a plurality of bristles. The handle portion, which is generally cylindraceous, includes a first end, a second end, a grip, and an end portion. The grip is positioned proximate to the first end and comprises a gripping feature. The gripping feature is configured to facilitate gripping of the cleaning apparatus by a user. The end portion is positioned proximate to the second end and includes an attachment structure. The attachment structure is configured enable attachment of the cleaning apparatus to an accessory. The bristle base is capable of being positioned adjacent to the first end of the handle portion. The plurality of bristles are attached to and project outwardly from the bristle base.

### PRIORITY

This application claims priority from the disclosure of U.S. Provisional Patent Application Ser. No. 60/822,315, entitled “Method and Apparatus for Cleaning Consumable Drink and Food Containers,” filed Aug. 14, 2006, the disclosure of which is incorporated by reference herein.

### BACKGROUND OF THE INVENTION

Embodiments of the present invention relate to a method and device that may be used to clean and/or sanitize an outer surface of the portion of a can or other drink or food container that will be opened and, more specifically, to a portable container cleaning apparatus for use with or without a sanitizing additive (e.g., chlorine, ethyl alcohol, etc.). Applying multiple soft bristles at the tip of an exemplary apparatus, used with or without sanitizing agents, a can/container may be cleaned and/or sanitized of certain hazardous and/or noxious materials and will be safe for consumption. As used herein, the term “sanitized” is not intended to be limited to a level of cleanliness amounting to “sterilized,” and should be read to include situations where a container is generally cleaner in some degree after use of embodiments of the apparatus disclosed herein than the container was before use of such embodiments.

Drink and food containers, such as cans, bottles, jars, Aseptic packages/pouches, etc. may sometimes be sanitized for consumers at the point of production and processing. In particular, metal packaging may provide an appreciable degree of protection from outside contaminants entering into a drink or food container. Once shipped from the production point and into storage and ultimately the consumer supply chain, some of the sanitation processes and procedures may be at risk in some circumstances, such as those related to the condition of the outside of such containers. Specifically, and for purposes of illustration only, beverage cans that have had the exterior of the top of the sealed can exposed in storage or in retail environments may, in some situations, have had contact with a multitude of contaminants and toxins found in such open environments, including pesticides, solvents, detergents, dust, and/or other caustic and dangerous or otherwise undesirable elements.

While a variety of devices and methods have been made and used to clean a portion of a container, it is believed that no one prior to the inventors has made or used a device or method as recited in the claims.

### BRIEF DESCRIPTION OF THE FIGURES

The accompanying drawings, which are incorporated in and constitute a part of this specification, illustrate versions of the invention, and, together with the general description of the invention given above, and the detailed description of the versions given below, serve to explain the principles of the present invention.

FIG. 1 is a perspective view of an exemplary cleaning apparatus and a container.

FIG. 2 is an end view of an exemplary cleaning apparatus.

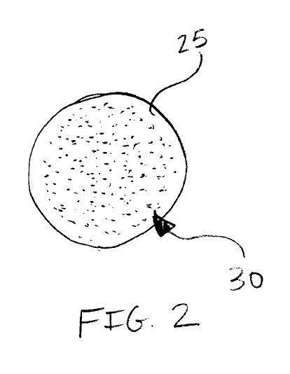

FIG. 3 is a partial side view of an alternate embodiment of a cleaning apparatus.

FIG. 4 is a side view of an alternate embodiment of a cleaning apparatus.

FIG. 5 is a side view of an alternate embodiment of a cleaning apparatus with bristles that are retractable within a handle portion.

FIG. 6 is a cross-sectional view of an alternate embodiment of a cleaning apparatus, revealing an internal screw mechanism configured to retract/extend a bristle base and bristles.

FIG. 7 is a perspective view of an alternate embodiment of a cleaning apparatus comprising an internal slide mechanism configured to retract/extend a bristle base and bristles.

FIG. 8 is a perspective view of an alternate embodiment of a cleaning apparatus comprising an internal spring mechanism configured to retract/extend a bristle base and bristles.

FIG. 9 is a side view of an alternate embodiment of a cleaning apparatus comprising an interior reservoir containing a cleaning agent.

FIG. 10 is a partial side view of an alternate embodiment of a cleaning apparatus comprising an interior reservoir containing a cleaning agent.

FIG. 11 is a partial side view of an alternate embodiment of a cleaning apparatus comprising a cleaning member positioned within bristles.

FIG. 12 is a side view of an alternate embodiment of a cleaning apparatus comprising a cleaning member.

FIG. 13 is a perspective view of an alternate embodiment of a cleaning apparatus comprising a housing with an opening to expose bristles.

### DETAILED DESCRIPTION

Numerous objects, features and advantages of the present invention will be readily apparent to those of ordinary skill in the art upon a reading of the following description of merely illustrative embodiments of the present invention when taken in conjunction with accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

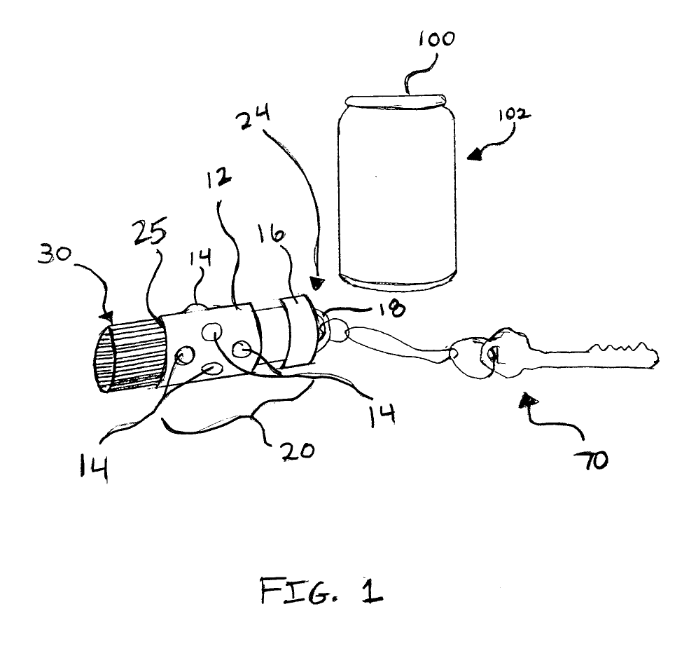

FIG. 1 illustrates an exemplary embodiment of a cleaner (10) and a beverage can (102). In the illustrated version, cleaner (10) comprises a handle portion (20), a bristle base (25) and bristles (30). As shown, handle portion (20) comprises a grip (12), an end portion (16), and an attachment structure (18) in the form of a loop. As will be appreciated, a user may hold cleaner (10) by grip (12), and use bristles (30) to remove debris from and/or otherwise clean the top (100) of a beverage can (102). While a standard beverage can (102) is shown and described herein, it is contemplated that cleaner (10) may be used to clean a variety of other types of cans and containers. Still other suitable uses for cleaner (10) will be apparent to those of ordinary skill in the art.

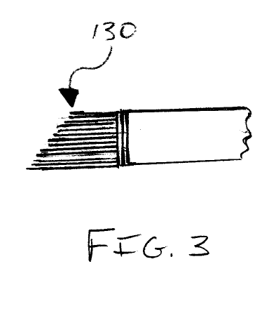

Bristles (30) may comprise a material similar to material used in bristles for conventional toothbrushes. For instance, bristles (30) may be generally stiff, bushy, formed of synthetic fibers, or have any other suitable properties. It will also be appreciated that bristles (30) may comprise a plurality of materials for a given cleaner (10). For instance, in one embodiment several bristles (30) are generally fibrous, with others on the same cleaner (10) being a rubber material. In another embodiment, all of the bristles (30) on a cleaner (10) are formed of a rubber material. Bristles (30) may all be substantially the same length, as in the embodiment shown in FIGS. I and 2, or may have different lengths. For example, as shown in FIG. 3, the bristles (130) may be configured to collectively form an angled edge. Still other alternative materials and configurations for bristles (30) will be apparent to those of ordinary skill in the art. It will also be appreciated that bristles (30) may be secured to bristle base (25) in any suitable fashion.

In the embodiment shown in FIG. 1, handle portion (20) is generally cylindraceous. Handle portion (20) may be formed of a plastic, metal, or any other suitable material, including combinations of materials. Grip (12) may be formed of a rubber material or any other suitable material(s). In the illustrated version, grip (12) comprises a plurality of protrusions (14) configured to facilitate gripping of the same. Alternatively, a grip may comprise other features such as recesses, ridges, knurling, etc., or no such features at all.

As shown in FIG. 1, end portion (16) is provided on the proximal end (24) of handle portion (20). In this example, end portion (16) includes attachment structure (18). Attachment structure (18) may be configured to allow cleaner (10) to be attached to an accessory (70). As shown in FIG. 1, accessory (70) comprises a key chain. However, accessory (70) may comprise a belt loop, wallet, purse, cellular phone, PDA, portable electronic device, or any other suitable device. Of course, as with other components described herein, such components are merely optional, and may be substituted, supplemented, or omitted as desired.

As shown in FIG. 1, cleaner (10) has a diameter that is less than the diameter of can (102). Accordingly, in an exemplary use, cleaner (10) is moved in an orbital motion, with bristles (30) engaged with top (100) of can (102) to remove debris and otherwise clean top (100). Alternatively, cleaner (10) may have a diameter that is greater than or equal to the diameter of can (102), such that cleaner (10) is simply rotated about an axis in common with can (102), with bristles (30) engaged with top (100) to remove debris and otherwise clean top (100). Still other suitable configurations of cleaner (10) relative to can (102), and other suitable methods of using cleaner (10), will be apparent to those of ordinary skill in the art.

In an alternate embodiment (not shown), the grip (12) is configured to reciprocate relative to the bristles (30) and the handle portion (20). In this embodiment, the grip may be used to selectively cover and uncover at least a portion of bristles (30), thereby providing some degree of protection to the bristles (30).

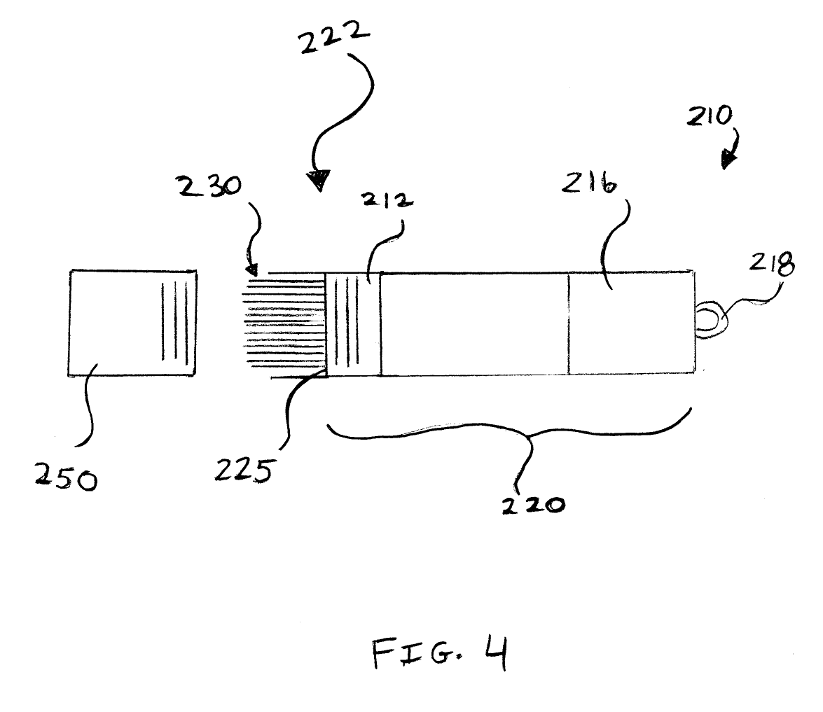

FIG. 4 illustrates another embodiment, wherein a cleaner (210) comprises a handle portion (220), a bristle base (225), bristles (230), and a removable cap (250). Similar to the embodiment shown in FIG. 1, handle portion (220) comprises a grip (212), an end portion (216), and an attachment structure (218). In the illustrated version, removable cap (250) may be selectively secured relative to the distal end (222) of handle portion (220) to cover and uncover bristles (230). For instance, cap (250) may have a length that is greater than the length to which bristles (230) extend from handle portion (220).

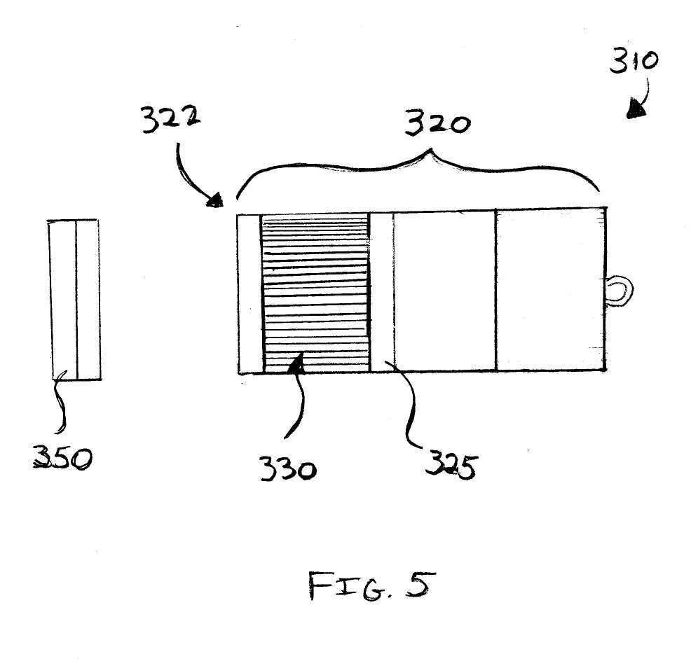

In yet another embodiment, shown in FIG. 5, handle portion (320) is configured such that bristle base (325) and bristles (330) may be selectively retracted therein. In this example, cleaner (310) also comprises a removable cap (350) configured to be secured relative to the distal end (322) and protect bristles (330) upon retraction of bristles (330) within handle portion (320). In other embodiments, including but not limited to those where bristles (330) may be retracted within handle portion (320), cap (350) may be omitted. It will also be appreciated that any suitable mechanisms may be used to retract bristles (330) within handle portion (320). By way of example only, such mechanisms may include a worm gear, a spring-loaded mechanism, one or more camming members, a ratchet mechanism, one or more sliders, etc.

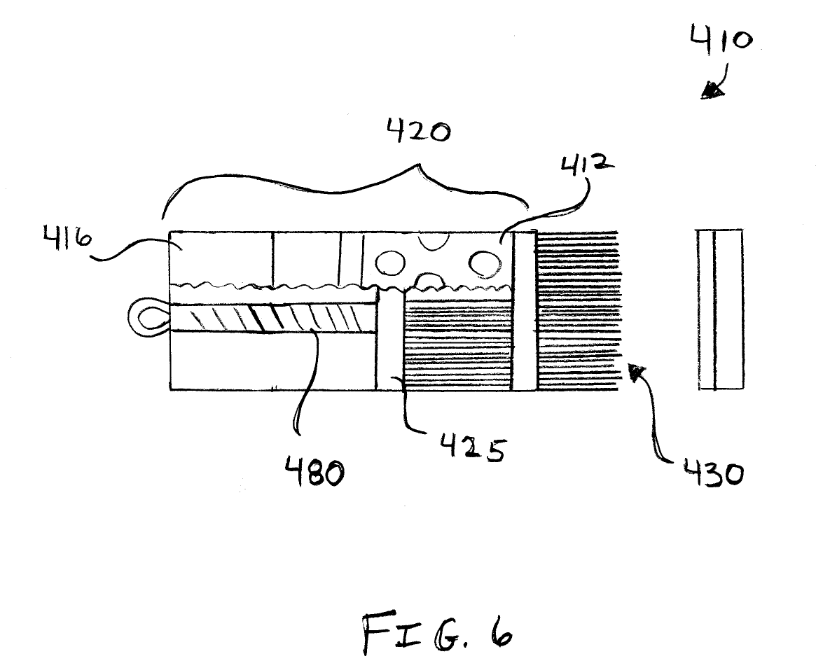

FIG. 6 shows another merely exemplary embodiment. In the illustrated version, cleaner (410) comprises a screw mechanism (480) configured to allow a user to retract bristle base (425) and bristles (430) into handle portion (420) by gripping a first portion of handle portion (420) and twisting a second portion of handle portion (420). For instance, with the present example, a user may retract bristle base (425) and bristles (430) by gripping grip (412) and twisting end portion (416).

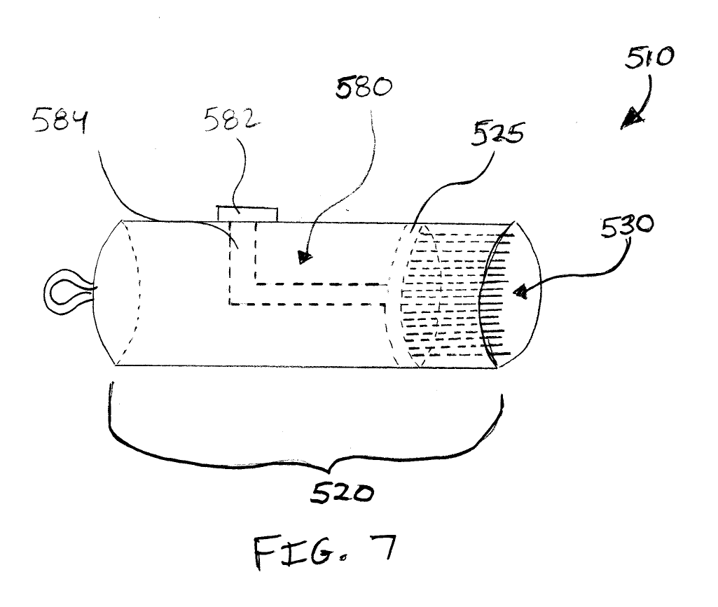

An alternate embodiment of a cleaner with retractable bristles is shown in FIG. 7. In this example, a cleaner (510) comprises a slide mechanism (580) configured to allow a user to retract bristle base (525) and bristles (530) into handle portion (520). As shown, slide mechanism (580) comprises a projection (582) and a connecting member (584). In the illustrated version, connecting member (584) connects projection (582) to bristle base (525). A user may expose or retract bristles (530) by grasping projection (582) and sliding bristle base (525) forward or backward as desired. The sidewall of handle portion (520) may include a slot (not shown) or other feature to permit such movement of projection (582) and connecting member (584). One or more detents (not shown), locking mechanisms (not shown), or other features may also be provided in order to removably secure the longitudinal position of projection (582) and connecting member (584) along handle portion (520). For instance, an underside of projection (582) may have one or more protrusions extending therefrom, configured to engage complimentary recess features formed in the sidewall of handle portion. Such features may be configured to resist axial forces encountered by bristles (530) during use of cleaner (510) to clean a top (100) of can (102), while permitting retraction of bristles (530) into handle portion (520) under sufficient urging by a user. Other ways in which such features may be provided will be apparent to those of ordinary skill in the art.

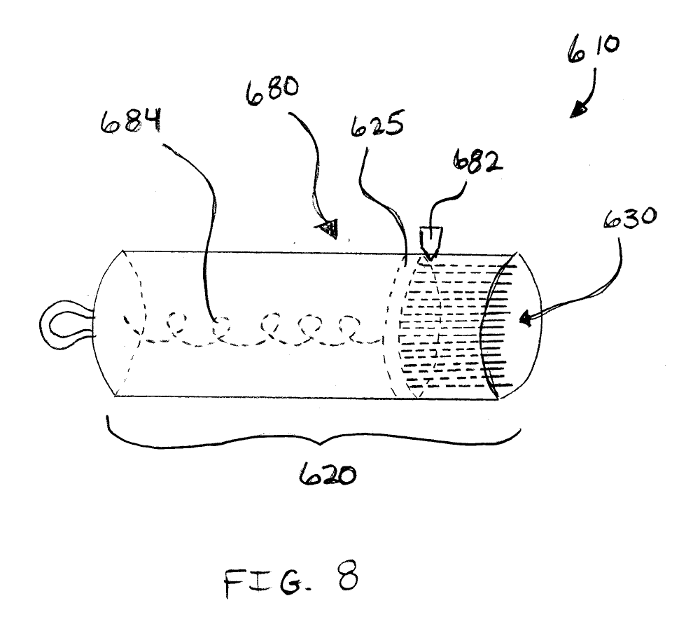

FIG. 8 depicts another embodiment of a cleaner with retractable bristles. As shown, a cleaner (610) comprises a spring mechanism (680) configured to allow a user to retract bristle base (625) and bristles (630) into handle portion (620). In this example, spring mechanism (680) comprises a coil spring (682), although any other suitable resilient material or structure may be used, and a button (684). Button (684) is configured to selectively engage and disengage bristle base (625) when button (682) is depressed by a user, while coil spring (682) is configured to urge bristle base (625) and bristles (625) outward once button (684) disengages bristle base (625).

In another embodiment (not shown), a sheath is provided, in which the entire cleaner may be inserted and held. Still other ways in which at least a portion of bristles may be selectively covered/uncovered or hidden/revealed will be apparent to those of ordinary skill in the art.

In other embodiments (not shown), the bristles are operable to move relative to the handle portion in a rotating or oscillating fashion. For instance, one or more motors (not shown) may be provided within handle portion. Such motor(s) may rotate the bristles collectively, individually, in sets, etc. Alternatively, a spring (not shown), other resilient member, or other mechanism may be provided such that a user may twist and release a first portion of handle portion while gripping a second portion of handle portion, whereupon bristles will rotate (e.g., even less than a full 360° rotation) or oscillate for a period of time. Alternatively, any other means, mechanisms, or features for providing rotating or oscillating movement of bristles relative to handle portion may be used.

In still another embodiment (not shown), a mechanism (e.g., a motor, etc.) is operable to vibrate bristles. Suitable mechanisms or features to provide such vibration will be apparent to those of ordinary skill in the art. It will also be appreciated that bristles may be configured to rotate, oscillate, vibrate, and/or reciprocate, or some combination thereof, in addition to engaging in other forms of motion.

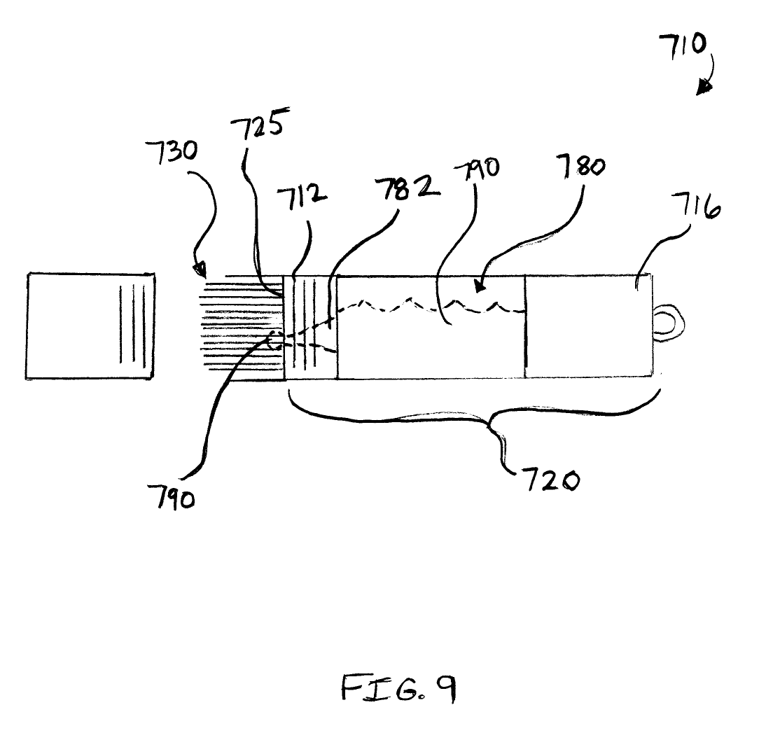

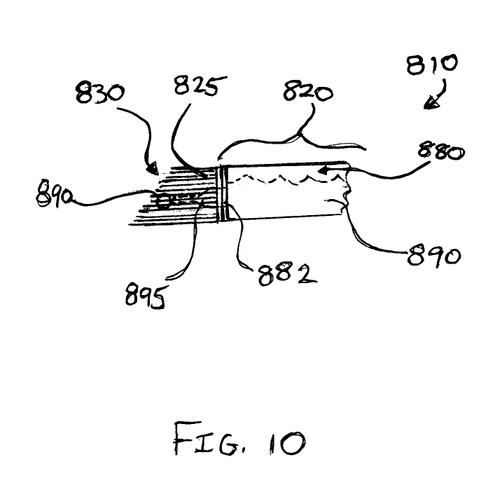

In yet other embodiments, such as the ones shown in FIGS. 9 and 10, a cleaning agent is provided in the cleaner. Such a cleaning agent may comprise any suitable substance, including but not limited to soaps, sanitizers, chlorine, ethyl alcohol, saline, water, etc.

In the embodiment shown in FIG. 9, a cleaner (710) comprises a handle portion (720), a bristle base (725) and bristles (730). In this example, the interior of handle portion (720) comprises a reservoir (780) holding cleaning agent (790). One or more channels (782) may be provided between reservoir (780) and bristle base (725) to permit distribution of the cleaning agent (790) to bristles (730). A valve or other feature (not shown) may be provided to prevent inadvertent leakage of cleaning agent (790). By way of example only, handle portion (720) may be configured such that cleaning agent (790) may be distributed from the reservoir to bristles (730) by a user squeezing handle portion (720), by a user rotating grip (712), by a user rotating end portion (716), by a user actuating a button (not shown) or other feature, or in any other suitable fashion. Still other suitable features for storing and distributing a cleaning agent from and/or within a cleaner (e.g., to bristles (730) or otherwise) will be apparent to those of ordinary skill in the art.

As shown in FIG. 10, a cleaner (810) comprises a handle portion (820), a bristle base (825) and bristles (830). In this example, bristles (830) have varying lengths and are shaped to form an edge to facilitate cleaning of debris from crevices. In addition, in the illustrated version, the interior of handle portion (820) comprises a reservoir (880) holding cleaning agent (890). This embodiment also comprises a channel (882) communicating with reservoir (880) and a spout (895) configured to distribute cleaning agent (890) to bristles (830). Cleaner 810 may be configured to allow distribution of cleaning agent (890) via any of the methods and devices described above with regard to the embodiment shown in FIG. 9 or in any other suitable way.

In some embodiments (not shown) where a cleaning agent reservoir is provided within handle portion, handle portion may also comprise a port (not shown) for refilling the reservoir. In still other embodiments, a cleaning agent is provided in a replacable cartridge (not shown) or other feature.

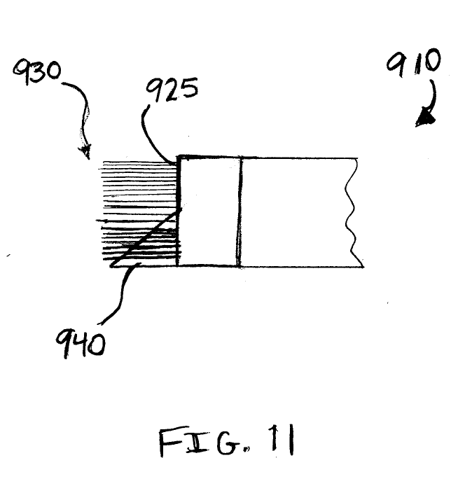

In the embodiment shown in FIG. 11, a cleaner (910) comprises a cleaning member (940), which is provided near bristles (930). Cleaning member (940) may comprise a generally soft material (e.g., rubber, a foam, etc.), and may have a slanted, edge-like configuration. In this example cleaning member (940) extends from bristle base (925) and is positioned within bristles (930). In other embodiments, cleaning member (940) is positioned about or external to bristles (930). Other suitable configurations for a cleaning member (940) will be apparent to those of ordinary skill in the art. It will also be appreciated that cleaning member (940) may assist bristles (930) in removing contaminants or debris from a container, such as from the top (100) of the can (102) shown in FIG. 1.

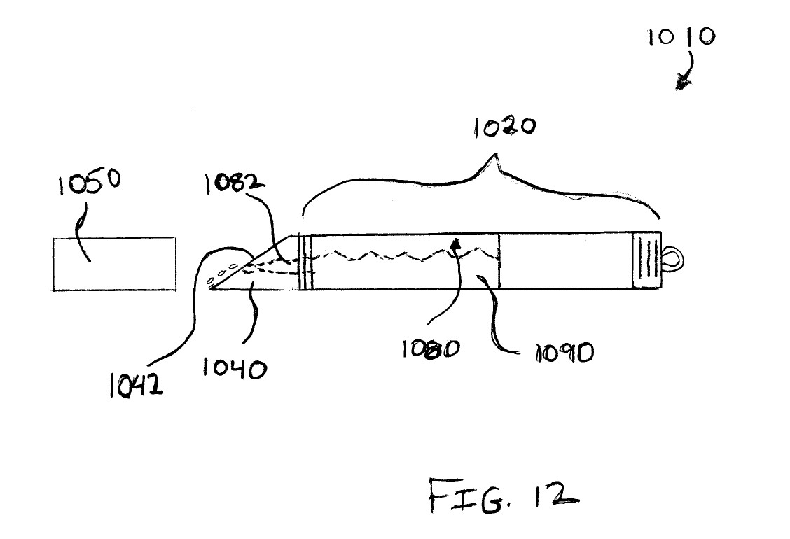

FIG. 12 illustrates another alternate embodiment. In FIG. 12, a cleaner (1010) comprises a handle portion (1020), a cleaning member (1040) and a removable cap (1050). In this embodiment, the cleaning member (1040) is configured to remove contaminants or debris from a container without the aid of bristles, as described in other embodiments. In the illustrated version, the interior of handle portion (1020) comprises a reservoir (1080) configured to hold a cleaning agent (1090). Cleaning member (1040) and handle portion (1020) further comprise a channel (1082) in communication with reservoir (1080) configured to enable delivery of cleaning agent (1090) to a front surface (1042) of cleaning member (1040). It will be appreciated that alternate embodiments of a cleaner may comprise a cleaning member, such as the one shown in FIG. 12, without including a cleaning agent or means for distribution thereof. Furthermore, embodiments having a cleaning member may include bristles that extend from the cleaning member; bristles that extend from within the cleaning member (e.g., the cleaning member surrounds the bristles); bristles that are external to the cleaning member (e.g., the bristles surround the cleaning member); any other suitable relationship, arrangement; or configurations of bristles relative to a cleaning member, or no bristles at all.

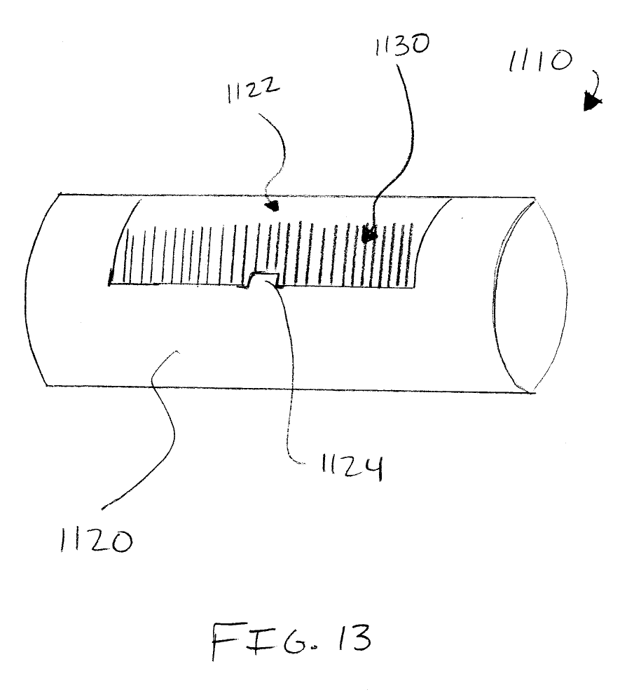

Yet another alternate embodiment is shown in FIG. 13. In this example, a cleaner (1110) comprises a housing (1120) configured to contain bristles (1130). Bristles (1130) may be stationary within housing (1120). In the illustrated version, housing (1120) comprises an opening (1122) and a door (not shown) configured to selectively cover opening (1122). In this embodiment, the door is configured to slidably retract within housing (1120) in order to expose bristles (1130). As shown in FIG. 13, housing (1120) also comprises a raised latch (1124) configured to secure the door in a closed position, thereby protecting bristles (1130). The width of the door may be greater than the width of a standard soft drink container, or any other suitable container, thereby allowing a user to remove contaminants and debris from the top of the container when the door is open and the bristles (1130) are exposed.

It will therefore be appreciated that, to the extent that bristles are used, bristles may extend longitudinally outward from a handle portion, laterally outward from a handle portion (e.g., radially outward), or in any other suitable configuration.

Embodiments of the present invention (not shown) may also comprise utility features, in addition to bristles and/or a cleaning member. For example, a cleaner may include a standard bottle opener, such as those well known within the art, integral with the handle portion. In another embodiment, the handle portion of a cleaner may include a structure configured to facilitate the opening of a standard pull-tab can, such as those used for soft drinks. In one such embodiment, the tab-opening structure comprises a triangular shaped wedge configured to be urged between a can top and a tab, thereby facilitating opening of the container. In an alternate embodiment, the tab-opening structure comprises a slot in the handle portion configured to allow a user to insert the tab of a can into the slot, thereby providing additional leverage to facilitate lifting of the tab and opening of the container. Other suitable features for facilitating the opening of a container will be apparent to those of ordinary skill in the art.

It will also be appreciated that some embodiments may include at least one removable and/or replaceable component. By way of example only, bristles and/or a cleaning member may be removable and/or replaceable in some fashion. For instance, in some embodiments (not depicted) a bristle base, with bristles extending therefrom, may be “snap fit” into a handle portion, and may be removable therefrom. Thus, if bristles become worn or dirty, etc., a user may remove the base that the undesirable bristles extend from, relative to the handle portion, and “snap” a new bristle base into the handle portion, with new bristles extending therefrom. Similar features and techniques may be used for a cleaning member that is provided with or in lieu of bristles. In other embodiments, a handle portion (or other portion) may house a plurality of bristle bases or cleaning members. A replacement bristle base (with replacement bristles extending therefrom) and/or a cleaning member may thus be immediately available for replacing a used bristle base (with used bristles extending therefrom) or used cleaning member. Furthermore, such a replacement bristle base and/or cleaning member may be spring-loaded, otherwise resiliently loaded or biased, or otherwise configured, such that a user merely has to remove a used set of bristles or cleaning member from the handle portion, and a replacement set of bristles or cleaning member “pops out,” gets pulled out, or otherwise appears, to take the place of the used bristles or cleaning member. It will be appreciated that this may be accomplished using a variety of structures, configurations, or techniques. Another merely illustrative example of a component that may be removable and/or replaceable may include a reservoir that contains a cleaning agent, to the extent that a cleaning agent is used. Other ways in which bristles, a cleaning member, and or any other component may be replaceable in any suitable fashion will be apparent to those of ordinary skill in the art.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A cleaning apparatus, wherein the cleaning apparatus is configured to clean a consumable drink or food container, the cleaning apparatus comprising:
a. a handle portion, wherein the handle portion is generally cylindraceous, the handle portion comprising:
i. a first end,
ii. a second end,
iii. a grip, wherein the grip is positioned proximate to the first end and comprises a gripping feature, wherein the gripping feature is configured to facilitate gripping of the cleaning apparatus by a user, and
iv. an end portion, wherein the end portion is positioned proximate to the second end and comprises an attachment structure, wherein the attachment structure is configured to enable attachment of an accessory to the cleaning apparatus;
b. a bristle base, wherein the bristle base is selectively positionable adjacent to the first end of the handle portion; and
c. a plurality of bristles, wherein the plurality of bristles are attached to and project outwardly from the bristle base.

2. The cleaning apparatus of claim 1, wherein the gripping feature comprises at least one of protrusions, protuberances, recesses, ridges, or knurling.

3. The cleaning apparatus of claim 1, wherein the grip is configured to reciprocate relative to the plurality of bristles and the handle portion thereby enabling a user to selectively cover and uncover at least a portion of the plurality of bristles.

4. The cleaning apparatus of claim 1, further comprising a removable cap, wherein the removable cap is configured be secured to the handle portion and cover the plurality of bristles.

5. The cleaning apparatus of claim 1, further comprising a sheath, wherein the sheath is configured to house the handle portion, the bristle base, and the plurality of bristles.

6. The cleaning apparatus of claim 1, wherein the handle portion is configured to allow the bristle base to retract within the handle portion, thereby housing at least a portion of the plurality of bristles within the handle portion.

7. The cleaning apparatus of claim 6, further comprising a screw mechanism, wherein the screw mechanism is positioned within the handle portion and configured to enable a user to manipulate the bristle base by gripping the grip and twisting the end portion of the handle portion.

8. The cleaning apparatus of claim 6, further comprising a slide mechanism, wherein the slide mechanism comprises:
a. a projection, wherein the projection extends outside the handle portion, and
b. a connecting member, wherein the connecting member connects the projection to the bristle base,
wherein the slide mechanism is configured enable a user to manipulate the bristle base by grasping the projection and reciprocating the slide mechanism.

9. The cleaning apparatus of claim 6, further comprising a spring mechanism, wherein the spring mechanism comprises:
a. a button, wherein the button is configured to selectively engage and disengage the bristle base when the button is depressed by a user, and
b. a coil spring, wherein the coil spring is configured to urge the bristle base towards the first end of the handle portion when the button is disengaged from the bristle base.

10. The cleaning apparatus of claim 1, further comprising a motor, wherein the motor is configured to enable at least a portion of the plurality of bristles to rotate, oscillate, or vibrate.

11. The cleaning apparatus of claim 1, further comprising a resilient member, wherein the resilient member is housed within the handle portion and configured to enable a user to cause at least a portion of the plurality of bristles to rotate or oscillate by twisting and releasing the grip while gripping the end portion of the handle portion.

12. The cleaning apparatus of claim 1, wherein the cleaning apparatus further comprises:
a. a cleaning agent;
b. a reservoir, wherein the reservoir is positioned within the handle portion and configured to contain the cleaning agent;
c. a channel, wherein the channel is in communication with the reservoir and the bristle base and is configured to enable distribution of the cleaning agent to the plurality of bristles; and
d. a valve, wherein the valve is configured to prevent the cleaning agent from inadvertently passing through the channel.

13. The cleaning apparatus of claim 12, wherein the cleaning apparatus is configured to distribute the cleaning agent to the plurality of bristles in response to a user performing at least one of the following actions: squeezing the handle portion, rotating the grip, rotating the end portion, or actuating a button.

14. The cleaning apparatus of claim 1, further comprising a cleaning member, wherein the cleaning member is attached to the bristle base and is configured to have a substantially triangular cross-section.

15. The cleaning apparatus of claim 14, wherein the cleaning member comprises foam or rubber.

16. The cleaning apparatus of claim 1, further comprising a container opening device, wherein the container opening device is attached to the handle portion.

17. A cleaning apparatus, wherein the cleaning apparatus is configured to clean a consumable drink or food container, the cleaning apparatus comprising:
a. a handle portion, wherein the handle portion is generally cylindraceous, the handle portion comprising:
i. a first end,
ii. a second end,
iii. a grip, wherein the grip is positioned proximate to the first end and comprises a gripping feature, wherein the gripping feature is configured to facilitate gripping of the cleaning apparatus by a user, and
iv. an end portion, wherein the end portion is positioned proximate to the second end and comprises an attachment structure, wherein the attachment structure is configured to enable attachment of an accessory to the cleaning apparatus;
b. a base, wherein the base is positioned adjacent to the first end of the handle portion; and
c. a cleaning member, wherein the cleaning member is attached to the base and has a substantially triangular cross-section.

18. The cleaning apparatus of claim 17, wherein the cleaning member comprises at least one of rubber, foam, or bristles.

19. A method of cleaning the top of a beverage can, the beverage can having a diameter and defining a longitudinal axis, the method comprising:
a. providing a cleaning apparatus, the cleaning apparatus comprising a cylindraceous handle portion and bristles extending from the cylindraceous portion, wherein the bristles are arranged to have a cross section forming a disc, wherein the diameter of the disc is less than the diameter of the top of the beverage can;
b. engaging the bristles with the top of the beverage can; and
c. moving the bristles in an orbital motion, relative to the longitudinal axis defined by the beverage can, against the top of the beverage can.

20. The method of claim 1, wherein the cleaning apparatus further comprises a reservoir housing a cleaning agent, the method further comprising dispensing the cleaning agent on one or both of the bristles or the top of the can.
